(19) United States
(12) Patent Application Publication
(10) Pub. No.: US 2019/0005463 A1
(43) Pub. Date: Jan. 3, 2019

(54) VOICE OVER INTERNET PROTOCOL CALLING TO A SET OF DEVICES WITHIN TEMPORAL OR SPATIAL BOUNDS

(71) Applicant: MICROSOFT TECHNOLOGY LICENSING, LLC, REDMOND, WA (US)

(72) Inventors: MATTHEW JUSTIN BURDICK, SUNNYVALE, CA (US); MAHESH PASUPULETI, UNION CITY, CA (US)

(21) Appl. No.: 15/636,988

(22) Filed: Jun. 29, 2017

(51) Int. Cl. G06Q 10/10; G10L 25/54; G06F 17/30

(52) U.S. Cl. CPC G06Q 10/1097; G06Q 10/1091; G10L 17/22; G06F 17/3074; G06F 17/30023; G10L 25/54

(57) ABSTRACT

A call initiation input is detected, that initiates a call to one or more recipients. Recipient identifying criteria are received and a recipient device is identified based on the recipient identifying criteria. The recipient identifying criteria can include such things as a geographical location, a timespan, among others. One or more recipient devices are identified based on the recipient identifying criteria, and voice over Internet protocol (VOPI) communication logic is controlled to communicate with the identified recipient device(s).

### BACKGROUND

Computing systems are currently in wide use. Some computing systems allow people or devices to communicate with one another using voice over Internet protocol (VoIP) technology. These types of systems receive a voice input, packetize it and identify a recipient device that is to receive a call. They send the packets to the recipient device where it is converted back to audio information and played to the user of the recipient device.

In current systems, a caller normally needs to know the identity of the recipient in order to make a VoIP call. This is similar to other types of communications, such as cellular or messaging communications, where the initiator of the message needs to know the identity of the recipient, or the identity of the recipient's device.

The discussion above is merely provided for general background information and is not intended to be used as an aid in determining the scope of the claimed subject matter.

### SUMMARY

A call initiation input is detected, that initiates a call to one or more recipients. Recipient identifying criteria are received and a recipient device is identified based on the recipient identifying criteria. The recipient identifying criteria can include such things as a geographical location or a timespan, among others. One or more recipient devices are identified based on the recipient identifying criteria, and voice over Internet protocol (VoIP) communication logic is controlled to communicate with the identified recipient device(s).

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIGS. 1A and 1B (collectively referred to herein as FIG. 1) show a block diagram of one example of a communication system architecture.

FIG. 2 is a block diagram showing one example of a computing system in more detail.

FIG. 3 is a flow diagram illustrating one example of the operation of the architecture shown in FIG. 1 in performing VoIP calling based on temporal or spatial recipient identifying criteria.

FIGS. 3A and 3B show examples of user interface displays.

FIG. 4 is a flow diagram illustrating one example of the operation of the architecture shown in FIG. 1 in identifying one or more recipient devices for a VoIP call based on recipient identifying criteria.

FIG. 5 is a block diagram showing one example of the architecture illustrated in FIG. 1, deployed in a cloud computing architecture.

FIGS. 6-8 show examples of mobile devices that can be used in the architectures shown in the previous figures.

FIG. 9 is a block diagram showing one example of a computing environment that can be used in the architectures shown in the previous figures.

### DETAILED DESCRIPTION

As briefly mentioned in the background above, many communication systems require a user to know a phone number or other user-specific information in order to initiate communication with a person. This can be problematic in many different scenarios. For instance, many workers in a workplace use their own mobile devices (such as smartphones) to communicate. They often use their own mobile devices to view communications from work or receive communications from work personnel, to check work shift information to see when they work, among other things. Also, some current computing systems manage shift information at a workplace so that managers can assign working personnel to different shifts or different locations, and so that the working personnel can check-in and check-out (or clock-in and clock-out) from work using the computing system. The computing system can maintain a personnel record so that it can communicate with the working personnel, using the mobile devices that are carried by the working personnel.

Given the dynamic nature of many places of work, and the continuously changing workforce, it can be difficult to keep track of phone numbers or user information and to know exactly who is working at a location at any given time. This is because current communication systems require a communication initiator (or call initiator) to know the phone number or user information of the recipients of the call. The problem can be exacerbated as the workforce becomes larger, and this can lead to the use of shared devices, such as pagers or shared phones, in order to help establish such communication. This can be relatively costly and cumbersome, because a worker then needs to carry not only a personal mobile device, but a shared device, such as a pager or a work phone.

The present description proceeds with respect to a system that allows a user to initiate a voice over Internet protocol (VoIP) call to a person or a group of people at a given time and/or at a desired location without knowing the phone number or personal information of the call recipients. The present system can do this by accessing updated schedule or shift information and identifying who is working at a desired location, and at a given time. It then initiates a VoIP call to that person or set of people, without the call initiator ever knowing the personal identity or phone number of the call recipients. This overcomes the approach taken by many current systems which have shared schedule information that provides general access to every worker phone number, or other user information. Thus, the current systems often require sharing of personal data, such as phone numbers or other user information.

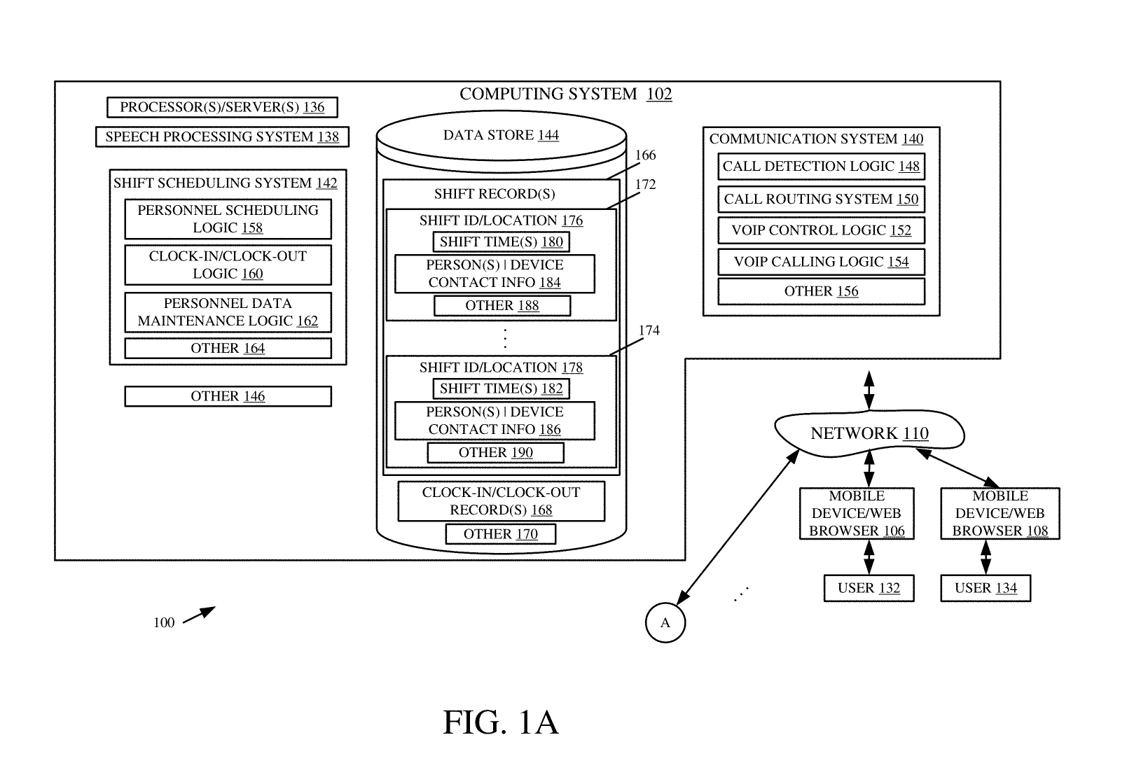

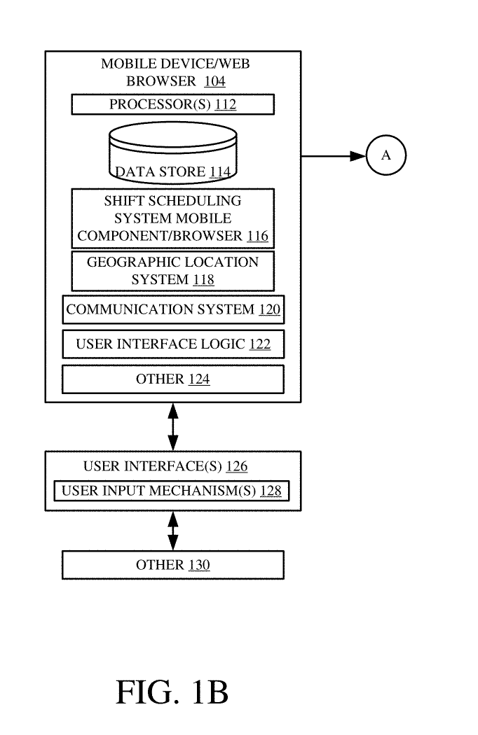

FIGS. 1A and 1B (collectively referred to herein as FIG. 1) illustrate a block diagram showing one example of a computing system architecture 100. Architecture 100 includes computing system 102 and a plurality of mobile devices/web browsers 104, 106 and 108, all communicatively coupled over network 100. Network 100 can be any of a wide variety of different types of networks, such as a wide area network, a local area network, a near field communication network, a cellular communication network, a wireless Internet connection type of network (e.g., WiFi), or a wide variety of other networks or combinations of networks.

In the example shown in FIG. 1, mobile devices/web browsers 104-108 can be any of a wide variety of different types of devices. For instance, users 130, 132 and 134 can use any of a variety of different types of devices with a web browser. The types of devices can include a kiosk for making calls to others, mobile devices, such as smart phones, tablet computers, etc. They are illustratively used by users 130, 132 and 134, respectively. Some examples are described in greater detail below. For purposes of the remaining description, devices 104-108 will be referred to as mobile devices, but this is by way of example only.

Before describing the overall operation of architecture 100 in more detail, a brief description of some of the items in architecture 100, and their operation, will first be provided. As shown in FIG. 1, mobile device 104 illustratively generates user interfaces 126 with user input mechanisms 128 for interaction by user 130. User 130 illustratively interacts with user input mechanisms 128 in order to control and manipulate mobile device 104, and possibly some portions of computing system 102. FIG. 1 also shows that mobile devices 106 and 108 can also generate interfaces for interaction by users 132-134, in a similar way.

In one example, mobile devices 104-108 can be similar or different devices. For purposes of the present description, it will be assumed that they are similar devices so that only mobile device 104 is described in more detail.

Mobile device 104 illustratively includes one or more processors 112, data store 114, shift scheduling system mobile component/browser 116, geographic location system 118, communication system 120, user interface logic 122, and it can include a wide variety of other items 124. As will be described with respect to computing system 102, system 102 illustratively includes a shift scheduling system that allows a manager to schedule personnel for work shifts. Shift scheduling system mobile component/browser 116 illustratively allows user 130 to access the shift scheduling system in computing system 102 using mobile device 104. Component 116 can run in a browser, or be a separate component that runs on mobile device 104.

Geographic location system 118 can be any of a wide variety of different geographic location systems, such as a GPS receiver, a cellular triangulation system, a dead reckoning system, or any of a wide variety of other systems that generate an indication as to the geographical position of mobile device 104. It can be used alone, or in conjunction with a remotely hosted location service, or in other architectures.

Communication system 120 illustratively allows mobile device 104 to communicate over network 110 with other mobile devices 106-108 and with computing system 102. Therefore, it may include VoIP components that allow user 130 to communicate with other users 132-134 using a wide area network. It can include a cellular communication system, a near field communication system, or any other of a wide variety of different types of communication systems that allow mobile device 104 to communicate with other devices or systems.

User interface logic 122 illustratively generates user interfaces 126 and detects user interaction with user input mechanisms 128. It can provide an indication of those detected interactions to other items in mobile device 104 or elsewhere in architecture 100.

FIG. 1 shows that, in one example, computing system 102 illustratively includes one or more processors or servers 136, speech processing system 138, communication system 140, shift scheduling system 142, data store 144, and it can include a wide variety of other items 146. Communication system 140, itself, illustratively includes call detection logic 148, call routing system 150, VoIP control logic 152, VoIP calling logic 154, and it can include other items 156. Shift scheduling system 142 can, itself, include personnel scheduling logic 158, clock-in/clock-out logic 160, personnel data maintenance logic 162, and it can include other items 164. Data store 144 can include shift records 166, clock-in/clock-out records 168, and a wide variety of other items 170. Shift records 166 can include various records 172-174 for different shifts or locations. Records 172-174 can include a shift identifier and/or location identifier 176-178. They can include shift times 180-182, person and device contact information 184-186, and they can include a wide variety of other items 188-190.

Briefly, in operation, speech processing system 138 can illustratively perform speech operations (such as speech recognition, speech synthesis, etc.). Call detection logic 148 in communication system 140 illustratively detects when a user device is attempting to contact another user device using VoIP communication. Call routing system 150 identifies the recipient device that is to receive the call and VoIP control logic 152 controls VoIP calling logic 154 to perform the call operations so that the two user devices (and their corresponding users) can communicate using VoIP.

Scheduling system 142 illustratively exposes an interface that allows an administrative user or management user to use personnel scheduling logic 158 in order to schedule different work personnel to work different shifts. Each shift may be identified by the role that the worker is to perform (such as “front desk”, “cashier #1”, “customer service counter”, among a wide variety of other items). It may also be identified by location, such as the location of the workplace, the location within a store, such as “stock room”, “freezer section”, “Pharmacy”, etc. The shift identifier (or role) and location is identified by items 176-178 in data store 144. Each shift can also have a time frame with start and end times identified by shift times 180-182. The particular people that have been assigned to a shift using personnel scheduling logic 158 are illustratively represented by the person and device contact information 184-186 in the shift record corresponding to that shift.

It will be appreciated that the information in data store 144 can be split up in other ways as well. For example, person and device contact information 184-186 can be stored separately, with an employee identifier (that points to the person and device contact information) stored in the shift records in data store 144. These and other arrangements are contemplated herein.

Clock-in/clock-out logic 160 illustratively exposes an interface that allows various users 130-134 to clock-in and clock-out for their assigned shifts. Clock-in/clock-out logic 160 illustratively maintains clock-in/clock-out records 168 to indicate when individual users have signed into their shift. It may also include logic that identifies whether the geographic location of the user (based upon the geographic location of the device that they are using) is within a geo-fence (or geographic location) of where the shift work is to take place. For instance, if a user is clocking in as a cashier in a retail location, then the clock-in/clock-out logic 160 may verify that the user is actually within the geographic region of that retail location when they are clocking in. This can be done in a variety of different ways. For instance, the shift scheduling system mobile component 116 (which may run in a browser) may send the geographic location obtained by geographic location system 118, when it sends a clock-in message to shift scheduling system 142. Also, logic 160 may ask for that information from mobile device 104, or the geographic verification can be performed in other ways as well.

Personnel data maintenance logic 162 illustratively maintains a record indicative of the persons and their device contact information that are scheduled to work in the various shifts. If that information changes (such as if a worker gets a new contact number or if a worker quits or a new worker starts), personnel data maintenance logic 162 can expose an interface that allows a user, an administrative user, a management user, or another type of user to change the personnel information or the device contact information associated with that worker.

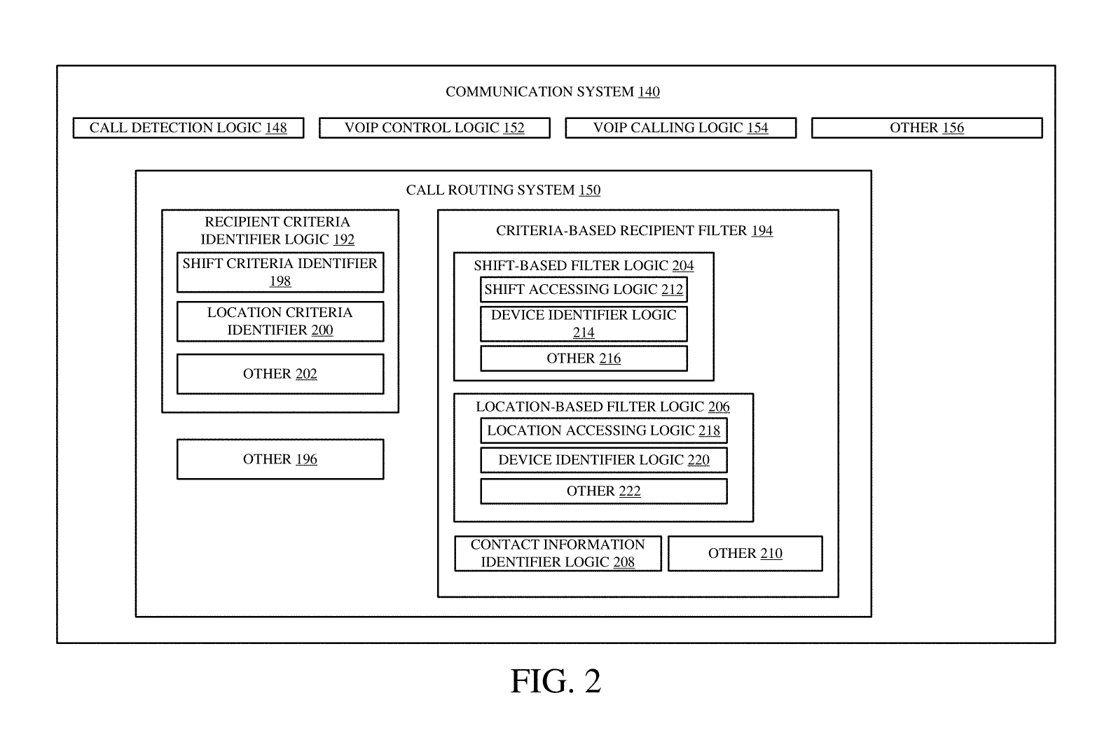

FIG. 2 is a block diagram showing one example of portions of communication system 140, in more detail. Specifically, FIG. 2 shows that call routing system 150 can include recipient criteria identifier logic 192, a criterion-based recipient filter 194, and it can include other items 196. Recipient criteria identifier logic 192 illustratively includes shift (e.g., time, role, etc.) criteria identifier 198, location criteria identifier 200, and it can include other items 202. Criteria-based recipient filter 194 can include shift-based filter logic 204, location-based filter logic 206, contact information identifier logic 208, and it can include a wide variety of other items 210. Shift-based filter logic 204, itself, illustratively includes shift accessing logic 212, device identifier logic 214, and it can include other items 216. Location-based filter logic 206, itself, can include location accessing logic 218, device identifier logic 220, and it can include other items 222.

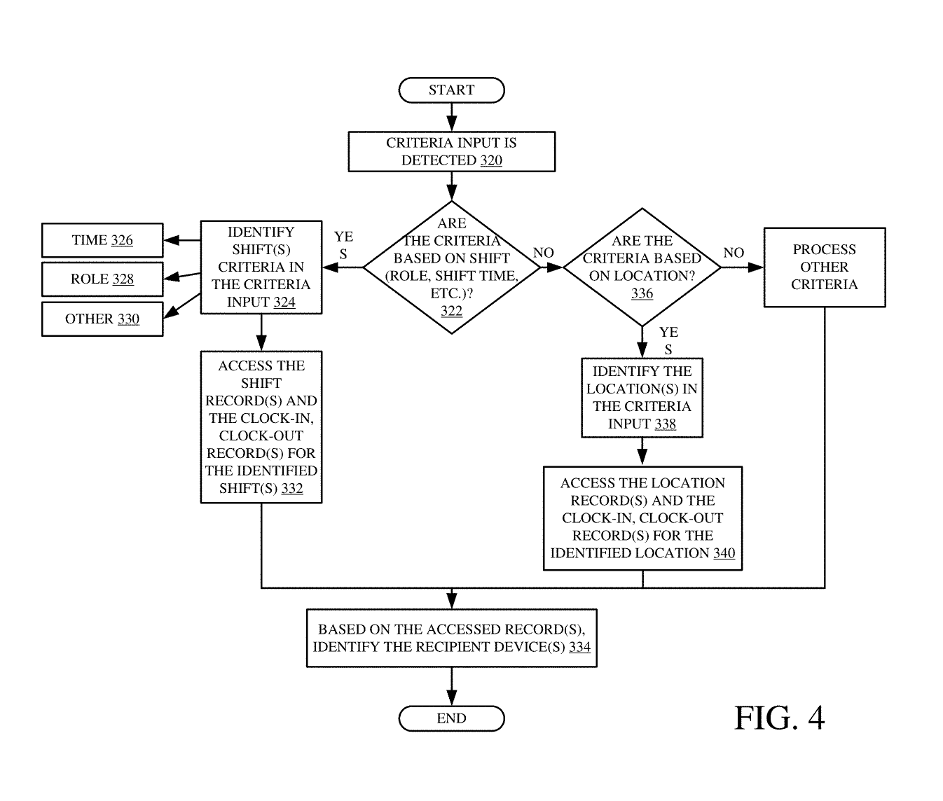

As is described in greater detail below with respect to FIG. 4, shift criteria identifier 198 identifies whether the call that is initiated is attempting to identify the recipients based on shift criteria such as the name of the shift for which workers are to be called, a role to be performed by the person assigned to the shift (e.g., cashier #4, “front desk”, etc.), the time that the shift is to take place (e.g., cashier #4, noon-8 PM, etc.), or other items that identify a particular shift. Location criteria identifier 200 identifies criteria in the call being initiated that attempt to identify recipients of the call based upon a location (e.g., workers at retail location #1, stock room workers, pharmacy workers, etc.). Once the recipient criteria identifier logic 192 has identified the particular criteria that the caller is using to identify the recipients of the call, then criteria-based recipient filter 194 identifies the recipient's device with which a VoIP call is to be conducted. Thus, where the criteria are shift-based criteria, then shift accessing logic 212 identifies the particular shift record 172-174 that matches those shift criteria. Device identifier logic 214 then identifies the particular device and contact information identifier logic 208 identifies the contact information 184-186 corresponding to the matching shift so that VoIP communication can be conducted with that particular device (or set of devices).

Where location criteria identifier 200 has identified the recipient criteria as being location criteria, then location accessing logic 218 filters the shift records by accessing the location information 176-178 to identify matching records. Then, the particular persons working at that location can be identified. Device identifier logic 220 then identifies the device and contact information identifier logic 208 identifies the contact information corresponding to persons working at the identified location.

Once the recipient device has been identified, then this is provided to VoIP control logic 152. Logic 152 generates control signals to control VoIP calling logic 154 to conduct a VoIP call between the caller and the recipient device or devices.

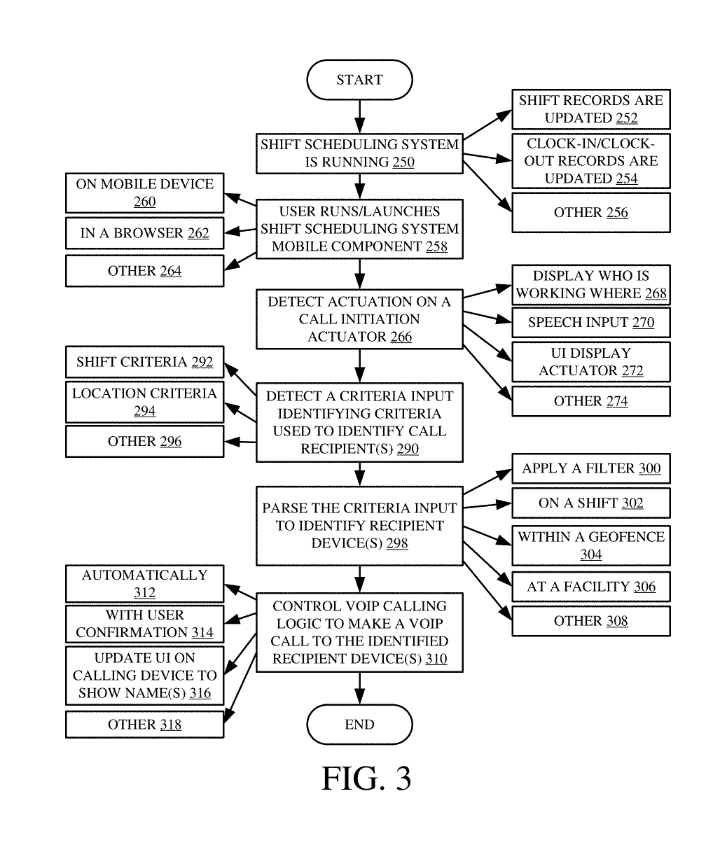

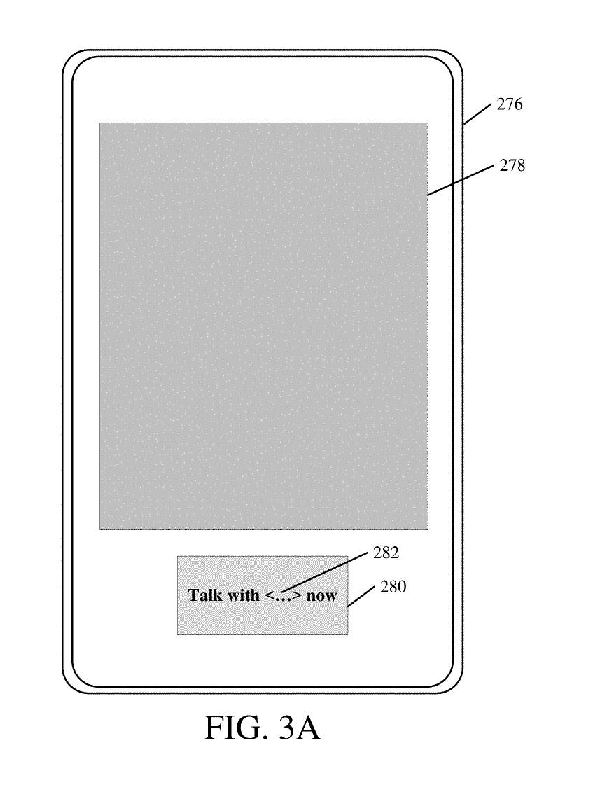

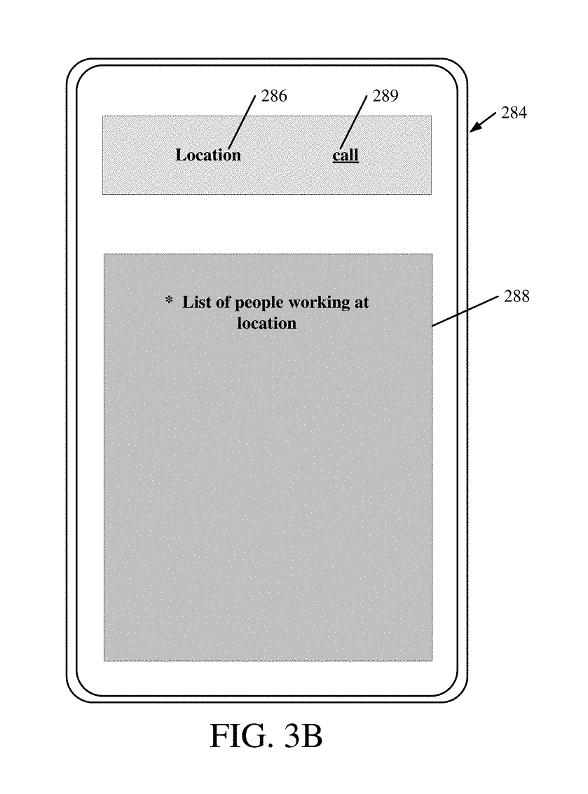

FIG. 3 is a flow diagram illustrating one example of the operation of the architecture and system shown in FIGS. 1 and 2 in allowing users to conduct VoIP communication with one another using location and/or time bounds to identify call recipients. It is first assumed that the shift scheduling system 142 is running in computing system 102. This is indicated by block 250 in the flow diagram of FIG. 3. In one example, the shift records 166 are updated, as indicated by block 252. The clock-in/clock-out records are also updated, as indicated by block 254. Other items can be running and updated as well, and this is indicated by block 256.

At some point, user 130 illustratively launches the shift scheduling system mobile component 116. This is indicated by block 258 in the flow diagram of FIG. 3. As mentioned above, this can be run as a separate component on mobile device 104. This is indicated by block 260. It can also be run in a browser as indicated by block 262, or in other ways as indicated by block 264.

User 130 then illustratively initiates a call to one or more other users 132-134. Call detection logic 148 then detects the actuation of a call initiation actuator. This is indicated by block 266. In one example, mobile device 104 can access shift scheduling system 142 and generate a user interface display indicating who is working different shifts, or different positions or roles on a given shift. Displaying who is working where is indicated by block 268. The user interface display may include user input mechanisms, such as actuators corresponding to each of the users or groups of users on the display. User 150 can actuate one of the actuators to initiate the call, using speech as indicated by block 270, using interaction with a user interface display actuator as indicated by block 272, or in a wide variety of other ways as indicated by block 274.

Recipient criteria identifier logic 192 then illustratively identifies the criteria that the call initiator is attempting to use to identify the call recipients. This is indicated by block 290 in the flow diagram of FIG. 3.

When user 130 has provided an input identifying recipients based on shift criteria, then the shift criteria identifier 198 processes the user input to identify the shift criteria being used (such as the shift identifier, the time of the shift, etc.). Identifying shift criteria is indicated by block 292.

When user 130 has provided an input using location criteria (such as the location of where the shift is to take place, the location within a particular business establishment, etc.). Then location criteria identifier 200 identifies the particular location criteria 294 that are used. Other recipient identifying criteria can be used as well, and this is indicated by block 296.

Criteria-based recipient filter 194 then parses or otherwise processes the identified criteria to identify recipient devices with which the VoIP call is to be conducted. For instance, shift accessing logic 212 can filter the shift records 166 based on shift identifying criteria and device identifier logic 214 can identify the particular recipient devices with which communication is to take place. This is indicated by block 298 in the flow diagram of FIG. 3. Applying a filter is indicated by block 300 and identifying the recipient devices based on shift criteria is indicated by block 302. Again, the shift criteria can include a shift role, a shift description or timeframe, or other shift identifying criteria.

If the recipient identifying criteria are location criteria, then location-based filter logic 206 illustratively identifies the recipients based upon the location criteria. The location criteria can identify a geographic region (such as a geo-fence) and recipient devices within that geographic region can be identified as the recipients of the call. This is indicated by block 304. The location of a particular facility may be identified, and user devices within that facility may be identified as the recipient devices. This is indicated by block 306. Logic 218 can filter the shift records 166 based on the location information and logic 220 can identify the devices in the matching records. Other criteria can be used as well, and this is indicated by block 308.

Once the recipient devices have been identified, contact information identifier logic 208 obtains the contact information for the identified recipient devices, and, this information is provided to VoIP control logic 152. Control logic 152 illustratively generates control signals to control VoIP calling logic 154 to call the identified recipient devices. This is indicated by block 310. This can be done automatically as indicated by block 312, or with user confirmation as indicated by block 314.

In one example, control logic 152 also updates the user interface on the calling device (e.g., on mobile device 104) to identify the names of the person or people who are being called. This is indicated by block 316. For instance, even if user 130 initiates a VoIP call by using a speech input such as “call the front desk”, the user interface display on mobile device 104 may be updated to show a message such as “calling the front desk, Jane Doe”. Controlling VoIP calling logic 154 can be done in a wide variety of other ways as well, to conduct a VoIP call between the caller's device and the recipient devices. This is indicated by block 318.

FIGS. 3A and 3B show two simplified user interface displays that can be used. In FIG. 3A, user interface display 276 is illustratively generated based on a user input at mobile device 104 requesting information about who is working on a particular shift. Display portion 278 may display who is working where, based upon that shift record. Actuator 280 illustratively includes a VoIP call initiation actuator which includes a personnel identifier 282. Based upon the information in the shift record being accessed, the personnel identifier 282 can be populated with the name of the person working in a particular role or on a particular shift, or with a set of people working in that role or on that shift. When the user actuates actuator 280 (such as by tapping on it) call detection logic 148 detects this as a call initiation.

FIG. 3B shows another user interface 284 that can be generated on mobile device 104. In user interface 284, the user may have identified a particular location 286 and display portion 288 illustratively displays a list of people working at that location. Call actuator 289 illustratively allows the user to initiate a call (such as by tapping actuator 289) to the list of people displayed in display portion 288.

FIG. 4 is a flow diagram illustrating one example of the operation of call routing system 150 in identifying the recipient devices of the VoIP call that was just initiated. It is first assumed that the caller has provided a criteria input, and that has been detected by recipient criteria identifier logic 192. This is indicated by block 320 in the flow diagram of FIG. 4. Again, this can be done by a speech input (such as “call all cashiers” or “call all workers at store XYZ” or “call the cashier working the 9:00 pm shift) or by user actuation of a user actuatable UI element, or in other ways. Recipient criteria identifier logic 192 then determines whether the criteria input are shift-based criteria or location-based criteria, or other criteria. This can be done based on the user actuatable UI element that was actuated, based on natural language understanding analysis of a speech input, or in other ways.

For instance, at block 322, shift criteria identifier 198 determines whether the user has provided shift-based criteria, such as a role performed by a person in the shift, such as another type of shift identifier, such as a shift time, etc. It then identifies the actual shift-based criteria that were input. This is indicated by block 324. The criteria, again, can include time-based criteria 326, role-based criteria 328, or other criteria 330.

Shift accessing logic 212 then accesses the shift records 166 to identify shift records that match the shift-based criteria, and then accesses the clock-in/clock-out records 168 for the shift records that match the shift-based criteria. This is indicated by block 332. In one example, logic 212 filters the shift records to identify only those shift records that match the shift-based criteria.

Once the matching shift records are identified, and the clock-in/clock-out records have been accessed to verify that the workers assigned to the matching shift records have clocked in, then contact information identifier logic 208 identifies the recipient devices corresponding to the matching shift records. This is indicated by block 334. Processing then continues at block 310 in FIG. 3.

If, at block 322, it is determined that the criteria input to identify the recipients are not shift-based criteria, then location criteria identifier 200 determines whether the recipient-identifying criteria are location-based criteria. This is indicated by block 336. Again, this can be done based on a user actuatable UI element that was activated, based on natural language processing performed on a speech input, or in other ways. If the recipient-identifying criteria are location-based criteria, then location criteria identifier 200 identifies the particular location criteria that were input. This is indicated by block 338. For instance, the location criteria may specify a location where the shift is to take place, another location such as the location of a store or warehouse, a location within a facility (such as a department, a particular cashier stand, etc.).

Location accessing logic 218 then accesses the shift records 166 and filters them based upon the location-based criteria to identify matching records. It also illustratively accesses the clock-in/clock-out records 168 to identify particular people who correspond to the matching shift records and who are clocked in. This is indicated by block 340 in the flow diagram of FIG. 4. Once the matching records and recipients are identified, then contact information identifier logic 208 identifies the recipient devices in the matching shift records, for the recipients. This is indicated by block 334. Again, once the recipient devices have been identified, processing continues at block 310 in the flow diagram of FIG. 3.

It can thus be seen that the present description describes a communication system which allows workers to communicate with one another at a worksite, using the personal mobile devices of the individual workers. Such workers may want to communicate with one another, while working, for a wide variety of different reasons. The description allows workers to communicate with one another, even though they do not know each other's personal information (such as names, telephone numbers, etc.). Instead, the caller can initiate the call by providing shift criteria, location criteria, time-based criteria, etc. The system identifies the particular recipients based upon shift records that may also include role-based information, time information, location information, etc. and allows the caller to initiate a VoIP call to one or more recipients, without ever sharing personal information with the caller. Thus, the communication system increases the security of the computing system, because calls can be made without ever sharing personal information. In addition, calls with groups of users can quickly be made, again, without disseminating any personal information. It also greatly enhances the user experience, because the caller need only know the non-personal information in order to initiate the call. All of this greatly enhances the security and operation of the computing system itself, as well as the user experience.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

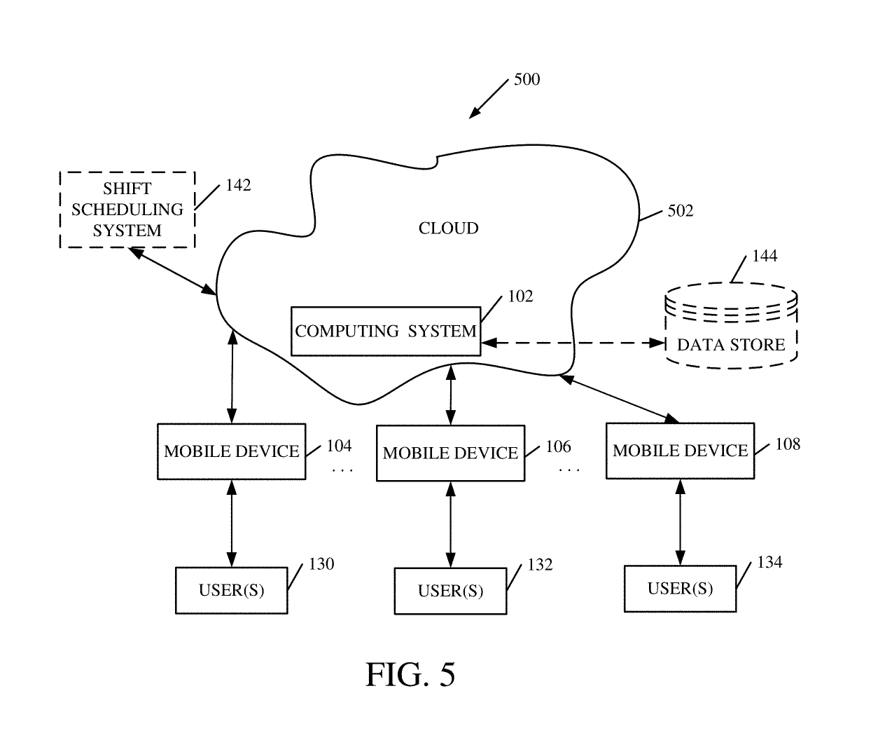

FIG. 5 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 5, some items are similar to those shown in FIG. 1 and they are similarly numbered. FIG. 5 specifically shows that computing system 102 can be located in cloud 502 (which can be public, private, or a combination where portions are public while others are private). Therefore, users 130, 132 and 134 use mobile devices 104, 106 and 108 to access those systems through cloud 502.

FIG. 5 also depicts another example of a cloud architecture. FIG. 5 shows that it is also contemplated that some elements of computing system 102 can be disposed in cloud 502 while others are not. By way of example, data store 144 can be disposed outside of cloud 502, and accessed through cloud 502. In another example, shift scheduling system 142 (or other items) can be outside of cloud 502. Regardless of where they are located, they can be accessed directly by devices 104-108, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

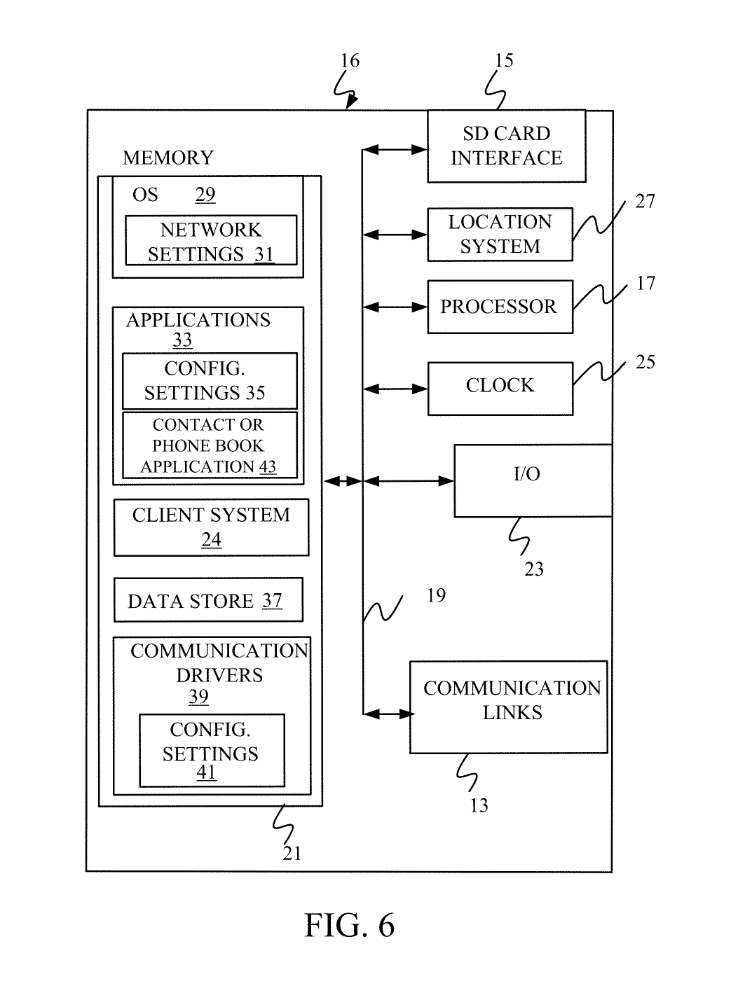

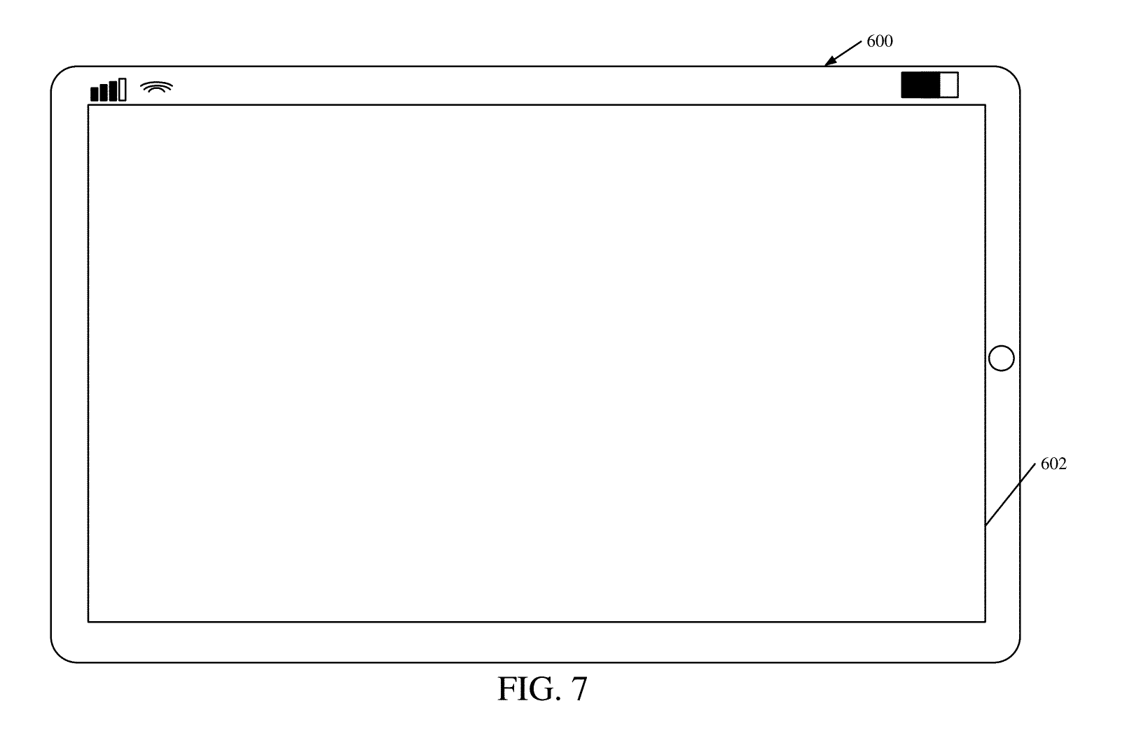

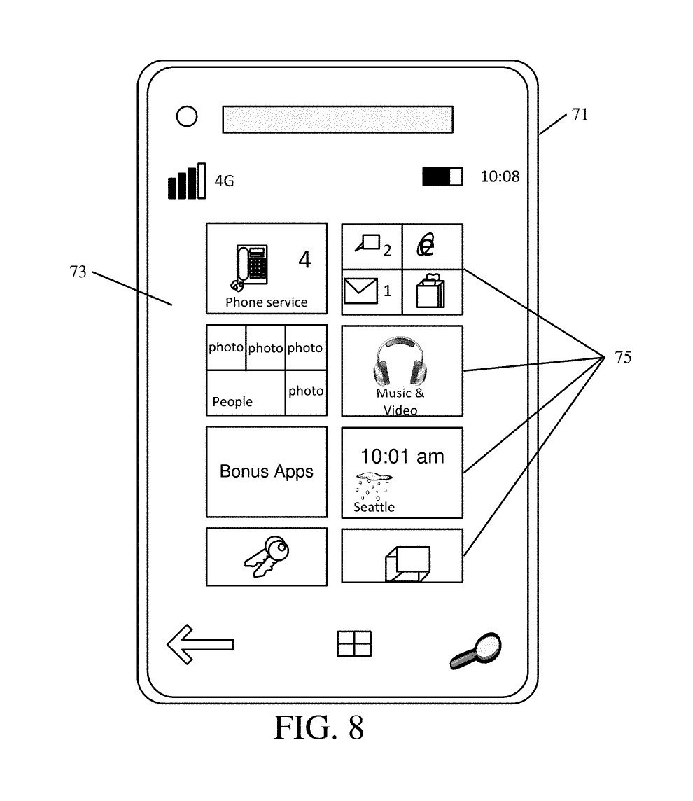

FIG. 6 is a simplified block diagram of one illustrative example of a handheld or mobile computing device that can be used as mobile devices 104-108 and that are shown in FIG. 6 as a user's or client's hand held device 16, in which the present system (or parts of it) can be deployed. FIGS. 7-8 are examples of handheld or mobile devices.

FIG. 6 provides a general block diagram of the components of a client device 16 that can run components of mobile devices 104-108 or that interacts with architecture 100, or both. In the device 16, a communications link 13 is provided that allows the handheld device to communicate with other computing devices and under some embodiments provides a channel for receiving information automatically, such as by scanning Examples of communications link 13 include VoIP logic, an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors or servers from other FIGS.) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one example in which device 16 is a tablet computer 600. In FIG. 7, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIG. 8 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

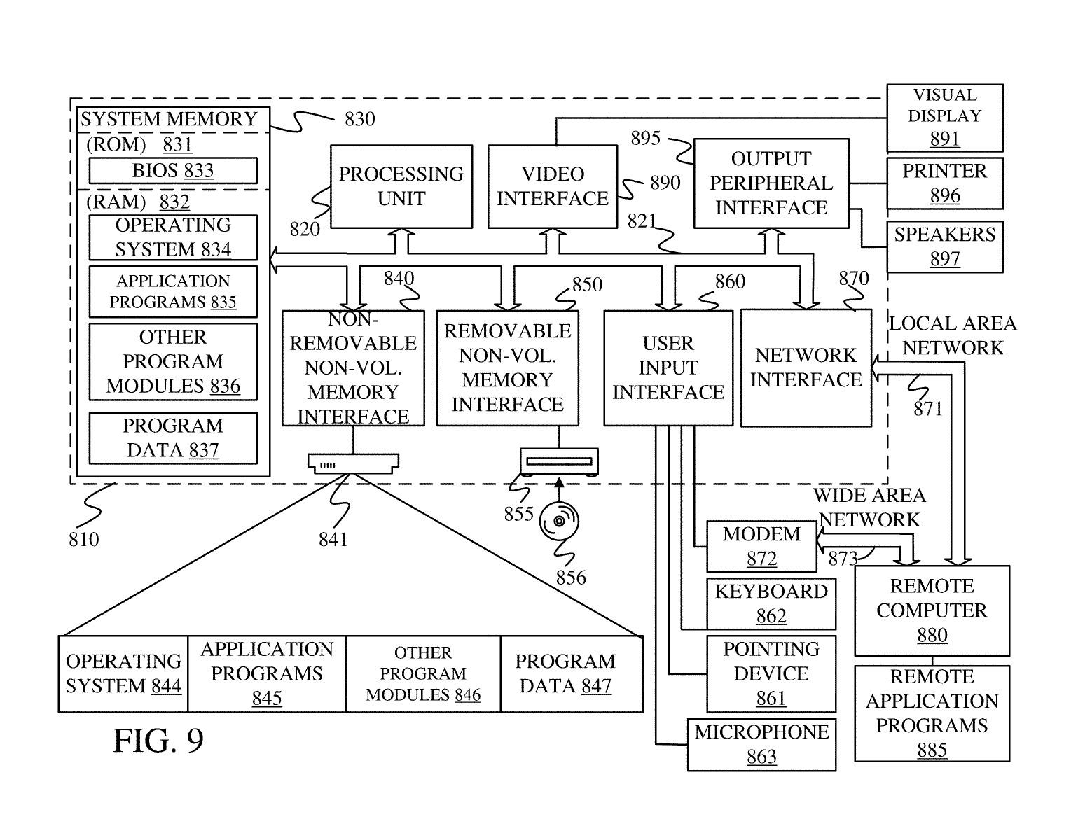

FIG. 9 is one example of a computing environment in which architecture 100, or parts of it, (for example) can be deployed. With reference to FIG. 9, an example system for implementing some embodiments includes a general-purpose computing device in the form of a computer 810. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 9 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 9 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

a shift scheduling system that maintains a set of shift records, each shift record identifying a different shift and device contact information identifying a mobile device corresponding to personnel assigned to the shift;

call detection logic configured to detect a call initiation input from a call initiator using a first mobile device;

a call routing system that filters the shift records, based on recipient identifying criteria in the call initiation input, to identify a matching shift record and to identify a recipient device based on the matching shift record;

voice over internet protocol (VoIP) calling logic that controls VoIP calls; and

VoIP control logic that receives an identity of the identified recipient device and generates a control signal to control the VoIP calling logic to conduct a VoIP call between the first mobile device and the identified recipient device.

Example 2 is the computing system of any or all previous examples wherein the call routing system comprises:

recipient criteria identifier logic configured to identify the recipient identifying criteria in the call initiation input.

Example 3 is the computing system of any or all previous examples wherein the recipient criteria identifier logic comprises:

shift criteria identifier logic configured to identify shift criteria, as the recipient identifying criteria.

Example 4 is the computing system of any or all previous examples wherein the call routing system comprises:

shift-based filter logic configured to filter the shift records based on the shift criteria to identify the matching shift record and the recipient device corresponding to the matching shift record; and

contact information identifier logic configured to identify contact information for the identified recipient device.

Example 5 is the computing system of any or all previous examples wherein the shift criteria identifier logic is configured to identify, as the shift criteria, time criteria indicative of a time span corresponding to a shift time span and wherein the shift-based filter logic is configured to filter the shift records based on the time criteria to identify the matching shift record.

Example 6 is the computing system of any or all previous examples wherein the recipient criteria identifier logic comprises:

location criteria identifier logic configured to identify location criteria, as the recipient identifying criteria.

Example 7 is the computing system of any or all previous examples wherein the call routing system comprises:

location-based filter logic configured to filter the shift records based on the location criteria to identify the matching shift record and the recipient device corresponding to the matching shift record; and

contact information identifier logic configured to identify contact information for the identified recipient device.

Example 8 is the computing system of any or all previous examples wherein the shift scheduling system comprises:

clock-in/clock-out logic configured to maintain clock-in/clock-out records indicative of personnel clocking into and clocking out of a shift.

Example 9 is the computing system of any or all previous examples wherein the call routing system is configured to access the clock-in/clock-out records and to identify the recipient device based on the clock-in/clock-out records.

Example 10 is a computer implemented method, comprising:

obtaining a set of shift records, each shift record identifying a different shift and device contact information identifying a mobile device corresponding to personnel assigned to the shift;

detecting a call initiation input from a call initiator using a first mobile device;

filtering the shift records, based on recipient identifying criteria in the call initiation input, to identify a matching shift record;

identifying a recipient device based on the matching shift record; and

generating a control signal based on the identified recipient device; and

controlling VoIP calling logic to conduct a VoIP call between the first mobile device and the identified recipient device, based on the control signal.

Example 11 is the computer implemented method of any or all previous examples wherein filtering the shift records comprises:

identifying the recipient identifying criteria in the call initiation input.

Example 12 is the computer implemented method of any or all previous examples wherein identifying the recipient criteria comprises:

identifying shift-based criteria, as the recipient identifying criteria.

Example 13 is the computer implemented method of any or all previous examples wherein filtering the shift records comprises:

filtering the shift records based on the shift-based criteria to identify the matching shift record and the recipient device corresponding to the matching shift record and wherein identifying the recipient device comprises identifying contact information for the identified recipient device.

Example 14 is the computer implemented method of any or all previous examples wherein identifying shift-based criteria comprises:

identifying, as the shift-based criteria, time criteria indicative of a time span corresponding to a shift time span and wherein filtering the shift records comprises filtering the shift records based on the time criteria to identify the matching shift record.

Example 15 is the computer implemented method of any or all previous examples wherein identifying the recipient identifying criteria comprises:

identifying location criteria, as the recipient identifying criteria.

Example 16 is the computer implemented method of any or all previous examples wherein filtering the shift records comprises:

filtering the shift records based on the location criteria to identify the matching shift record and the recipient device corresponding to the matching shift record and wherein identifying the recipient device comprises identifying contact information for the identified recipient device.

Example 17 is the computer implemented method of any or all previous examples and further comprising:

maintaining clock-in/clock-out records indicative of personnel clocking into and clocking out of a shift.

Example 18 is the computer implemented method of any or all previous examples and further comprising:

accessing the clock-in/clock-out records corresponding to the matching shift record to identify the recipient device based on the clock-in/clock-out records.

Example 19 is a computing system, comprising:

a shift scheduling system that maintains a set of shift records, each shift record identifying a different shift and device contact information identifying a mobile device corresponding to personnel assigned to the shift;

call detection logic configured to detect a call initiation input from a call initiator using a first mobile device;

shift-based filter logic configured to filter the shift records based on recipient-identifying shift criteria in the call initiation input to identify a matching shift record and a recipient mobile device corresponding to the matching shift record;

location-based filter logic configured to filter the shift records based on recipient identifying location criteria in the call initiation input to identify the matching shift record and the recipient mobile device corresponding to the matching shift record;

voice over internet protocol (VoIP) calling logic that controls VoIP calls; and

VoIP control logic that receives an identity of the identified recipient mobile device and generates a control signal to control the VoIP calling logic to conduct a VoIP call between the first mobile device and the identified recipient mobile device.

Example 20 is the computing system of any or all previous examples and further comprising:

shift criteria identifier logic configured to identify, as the shift criteria, time criteria indicative of a time span corresponding to a shift time span and wherein the shift-based filter logic is configured to filter the shift records based on the time criteria to identify the matching shift record.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
a shift scheduling system that maintains a set of shift records, each shift record identifying a different shift and device contact information identifying a mobile device corresponding to personnel assigned to the shift;
call detection logic configured to detect a call initiation input from a call initiator using a first mobile device;
a call routing system that filters the shift records, based on recipient identifying criteria in the call initiation input, to identify a matching shift record and to identify a recipient device based on the matching shift record;
voice over internet protocol (VoIP) calling logic that controls VoIP calls; and
VoIP control logic that receives an identity of the identified recipient device and generates a control signal to control the VoIP calling logic to conduct a VoIP call between the first mobile device and the identified recipient device.

2. The computing system of claim 1 wherein the call routing system comprises:
recipient criteria identifier logic configured to identify the recipient identifying criteria in the call initiation input.

3. The computing system of claim 2 wherein the recipient criteria identifier logic comprises:
shift criteria identifier logic configured to identify shift criteria, as the recipient identifying criteria.

4. The computing system of claim 3 wherein the call routing system comprises:
shift-based filter logic configured to filter the shift records based on the shift criteria to identify the matching shift record and the recipient device corresponding to the matching shift record; and
contact information identifier logic configured to identify contact information for the identified recipient device.

5. The computing system of claim 4 wherein the shift criteria identifier logic is configured to identify, as the shift criteria, time criteria indicative of a time span corresponding to a shift time span and wherein the shift-based filter logic is configured to filter the shift records based on the time criteria to identify the matching shift record.

6. The computing system of claim 4 wherein the recipient criteria identifier logic comprises:
location criteria identifier logic configured to identify location criteria, as the recipient identifying criteria.

7. The computing system of claim 6 wherein the call routing system comprises:
location-based filter logic configured to filter the shift records based on the location criteria to identify the matching shift record and the recipient device corresponding to the matching shift record; and
contact information identifier logic configured to identify contact information for the identified recipient device.

8. The computing system of claim 7 wherein the shift scheduling system comprises:
clock-in/clock-out logic configured to maintain clock-in/clock-out records indicative of personnel clocking into and clocking out of a shift.

9. The computing system of claim 8 wherein the call routing system is configured to access the clock-in/clock-out records and to identify the recipient device based on the clock-in/clock-out records.

10. A computer implemented method, comprising:
obtaining a set of shift records, each shift record identifying a different shift and device contact information identifying a mobile device corresponding to personnel assigned to the shift;
detecting a call initiation input from a call initiator using a first mobile device;
filtering the shift records, based on recipient identifying criteria in the call initiation input, to identify a matching shift record;
identifying a recipient device based on the matching shift record; and
generating a control signal based on the identified recipient device; and
controlling VoIP calling logic to conduct a VoIP call between the first mobile device and the identified recipient device, based on the control signal.

11. The computer implemented method of claim 10 wherein filtering the shift records comprises:
identifying the recipient identifying criteria in the call initiation input.

12. The computer implemented method of claim 11 wherein identifying the recipient criteria comprises:
identifying shift-based criteria, as the recipient identifying criteria.

13. The computer implemented method of claim 12 wherein filtering the shift records comprises:
filtering the shift records based on the shift-based criteria to identify the matching shift record and the recipient device corresponding to the matching shift record and wherein identifying the recipient device comprises identifying contact information for the identified recipient device.

14. The computer implemented method of claim 13 wherein identifying shift-based criteria comprises:
identifying, as the shift-based criteria, time criteria indicative of a time span corresponding to a shift time span and wherein filtering the shift records comprises filtering the shift records based on the time criteria to identify the matching shift record.

15. The computer implemented method of claim 13 wherein identifying the recipient identifying criteria comprises:
identifying location criteria, as the recipient identifying criteria.

16. The computer implemented method of claim 15 wherein filtering the shift records comprises:
filtering the shift records based on the location criteria to identify the matching shift record and the recipient device corresponding to the matching shift record and wherein identifying the recipient device comprises identifying contact information for the identified recipient device.

17. The computer implemented method of claim 16 and further comprising:
maintaining clock-in/clock-out records indicative of personnel clocking into and clocking out of a shift.

18. The computer implemented method of claim 17 and further comprising:
accessing the clock-in/clock-out records corresponding to the matching shift record to identify the recipient device based on the clock-in/clock-out records.

19. A computing system, comprising:
a shift scheduling system that maintains a set of shift records, each shift record identifying a different shift and device contact information identifying a mobile device corresponding to personnel assigned to the shift;
call detection logic configured to detect a call initiation input from a call initiator using a first mobile device;
shift-based filter logic configured to filter the shift records based on recipient-identifying shift criteria in the call initiation input to identify a matching shift record and a recipient mobile device corresponding to the matching shift record;
location-based filter logic configured to filter the shift records based on recipient identifying location criteria in the call initiation input to identify the matching shift record and the recipient mobile device corresponding to the matching shift record;
voice over internet protocol (VoIP) calling logic that controls VoIP calls; and
VoIP control logic that receives an identity of the identified recipient mobile device and generates a control signal to control the VoIP calling logic to conduct a VoIP call between the first mobile device and the identified recipient mobile device.

20. The computing system of claim 19 and further comprising:
shift criteria identifier logic configured to identify, as the shift criteria, time criteria indicative of a time span corresponding to a shift time span and wherein the shift-based filter logic is configured to filter the shift records based on the time criteria to identify the matching shift record.
